(19) United States
(12) Patent Application Publication
(10) Pub. No.: US 2011/0314970 A1
(43) Pub. Date: Dec. 29, 2011

(54) HAMMER WITH TITANIUM ALLOY STRIKING FACE

(76) Inventor: Yung-Shou Chen, Taichung Hsien (TW)

(21) Appl. No.: 12/824,986

(22) Filed: Jun. 28, 2010

(51) Int. Cl. B25D 1/02; B25D 1/06; B25D 1/04

(52) U.S. Cl. 81/24; 81/25; 254/26 R

(57) ABSTRACT

A hammer with a titanium alloy striking face includes a main body and a striking face. The striking face is made of β titanium alloy having a hardness above HRC 45. The main body is made of a metallic material, which is A164 titanium alloy, steel, or stainless steel. The hammer composed of the main body and the striking face complies with the standard of ASME.

### BACKGROUND OF THE INVENTION

(a) Field of the Invention

The present invention relates to a hammer with a titanium alloy striking face. The hammer includes a main body and a striking face. The main body is made of a metallic material, which is A164 titanium alloy, steel, or stainless steel. The striking face is made of β titanium alloy. The hammer composed of the main body and the striking face complies with the standard of ASME (American Society of Mechanical Engineers).

(b) Description of the Prior Art

A conventional hand-held tool, such as a hammer, is made of a single material, which is steel or steel alloy. The hammer has a striking face which is integrally formed with a main body. This hammer is not durable and has a short service life. Therefore, a hammer body made of titanium alloy and a striking face made of steel alloy are developed. The hardness of the steel alloy is greater than that of the titanium alloy. This type of hammer has a portion (hammer body) made of titanium alloy and another portion (striking face) made of steel alloy, as disclosed in U.S. Pat. No. 6,536,308.

According to the standard of ASME, the hardness of the striking face of the hammer must be above HRC 45. So far, no hammer made of a single material or made of two materials uses titanium alloy as the material of the striking face to comply with the standard of ASME.

### SUMMARY OF THE INVENTION

The primary object of the present invention is to provide a hammer with a titanium alloy striking face, which includes a main body and a striking face. The main body is made of a metallic material, which is A164 titanium alloy, steel, or stainless steel. The striking face is made of β titanium alloy having a hardness above HRC 45. The hammer composed of the main body and the striking face complies with the standard of ASME (B107.400-2008).

Another object of the present invention is to provide a hammer with a titanium alloy striking face, which has an opening at a connecting end of the main body. The main body further has a pin hole at one side thereof. The striking face has a protrusion to be inserted in the opening of the main body. A pin is inserted in the pin hole of the main body and a through hole of the protrusion so that the striking face and the main body are connected together.

A further object of the present invention is to provide a hammer with a titanium alloy striking face, which provides a magnetic block embedded in the pin hole after the pin is inserted in the pin hole of the main body and the through hole of the protrusion. The magnetic block is exposed out of the side of the main body. A nail trough is provided close to the magnetic block for insertion of nails.

### BRIEF DESCRIPTION OF THE DRAWINGS

FIG. 1 is a perspective exploded view according to a preferred embodiment of the present invention;

FIG. 2 is a side exploded view according to the preferred embodiment of the present invention;

FIG. 3 is a cross-sectional view according to the preferred embodiment of the present invention; and

FIG. 4 is a side view showing the preferred embodiment of the present invention coupled with a handle.

### DETAILED DESCRIPTION OF THE PREFERRED EMBODIMENTS

Embodiments of the present invention will now be described, by way of example only, with reference to the accompanying drawings.

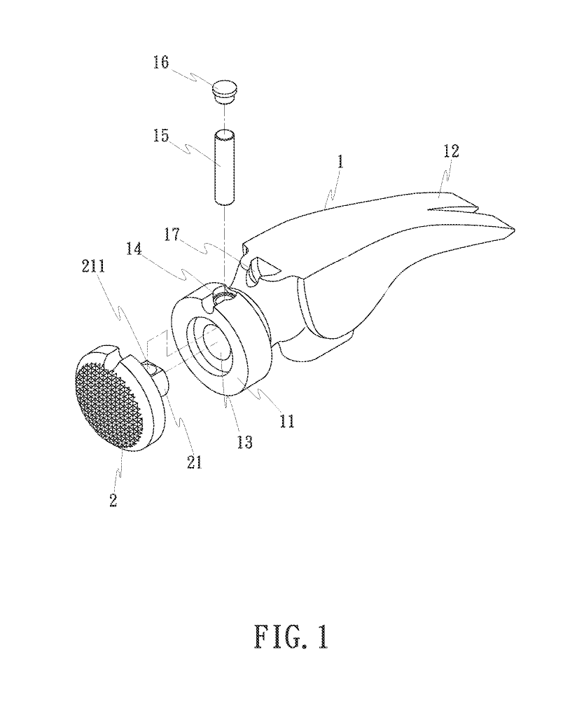

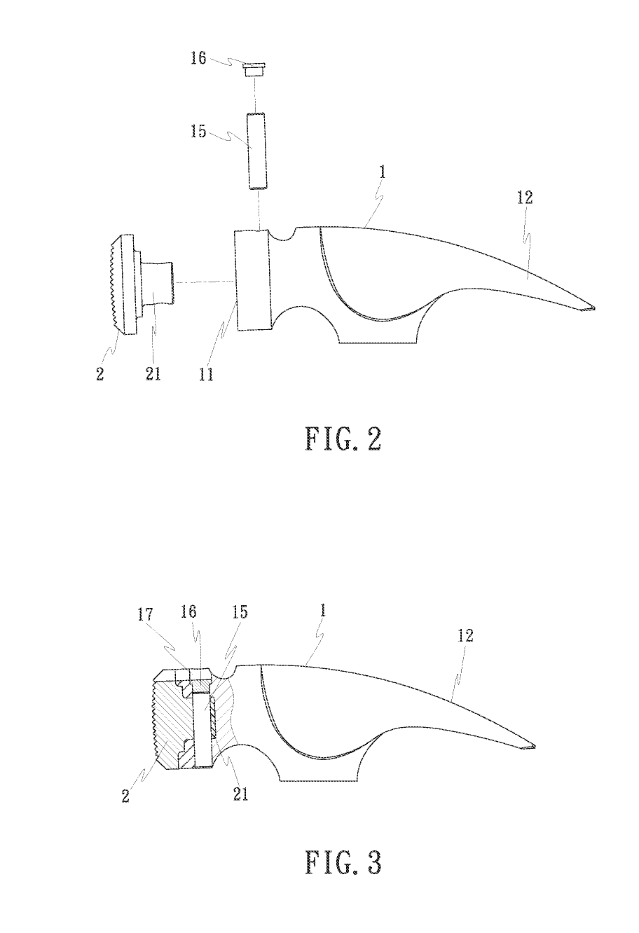

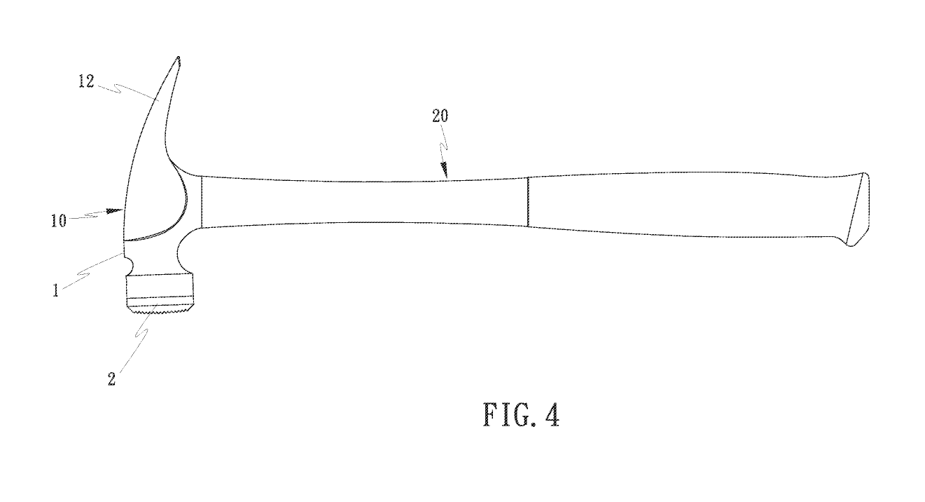

As shown in FIG. 1 to FIG. 3, a hammer 10 with a titanium alloy striking face according to a preferred embodiment of the present invention comprises a main body 1 and a striking face 2. One side of the hammer 10 is coupled with a handle 20, as shown in FIG. 4.

The main body 1 is made of a metallic material which is A164 titanium alloy, steel, or stainless steel. The main body 1 includes a connecting end 11 and a claw portion 12. The connecting end 11 has an opening 13, as shown in FIG. 3.

The striking face 2 is made of β titanium alloy having a hardness above HRC 45. The striking face 2 is coupled to the connecting end 11 of the main body 1. In this embodiment, the striking face 2 has a protrusion 21. The protrusion 21 is inserted into the opening 13, so that the striking face 2 is coupled to the connecting end 11 of the main body 1.

The main body 1 and the striking face 2 are two separate parts, which can be coupled together by other traditional techniques to make a hammer with a titanium alloy striking face. The hammer 10 can be made of a single material (for example, both the main body 1 and the striking face 2 are made of titanium alloy) or two materials (for example, the main body 1 is made of steel or stainless steel and the striking face 2 is made of titanium alloy). Because the striking face 2 is made of β titanium alloy having the hardness above HRC 45, the hammer of the present invention complies with the standard of ASME (B107.400-2008). It is novel to use the β titanium alloy as the material of the striking face 2.

As shown in the drawings, the main body 1 of the present invention further has a pin hole 14 at one side thereof. The pin hole 14 communicates with the opening 13. The protrusion 21 of the striking face 2 has a through hole 211 corresponding to the pin hole 14. When the protrusion 21 is inserted into the opening 13 of the main body 1, a pin 15 is inserted into the pin hole 14 of the main body 1 and the through hole 211 of the protrusion 21 to firmly secure the main body 1 and the striking face 2 together.

As shown in the drawings, after the pin 15 is inserted into the pin hole 14 of the main body 1 and the through hole 211 of the protrusion 21, a magnetic block 16 may be embedded in the pin hole 14, so that the magnetic block 16 is exposed out of the side of the main body 1, as shown in FIG. 3. A nail trough 17 is provided close to the magnetic block 16 for insertion of a nail (not shown in the drawings). The magnetic block 16 attracts the nail to be temporarily positioned there. The nail trough 17 is disposed close to the magnetic block 16, which can extend to the main body 1 and the striking face 2, as shown in FIG. 1.

The connection means of the main body 1 and the striking face 2 is not limited to this embodiment, but can be those in the conventional hammers. Besides, the shapes of the main body 1 and the striking face 2 can be varied as desired. The connection of the main body 1 and the striking face 2 can be done by welding, adhering, screwing or the like to connect the main body 1 and the striking face 2 into one piece.

Accordingly, the hammer with a titanium alloy striking face of the present invention is novel in that the β titanium alloy is used as the material of the striking face. Preferably, the main body 1 is made of A164 titanium alloy to make an entire titanium alloy hammer, complying with the standard of ASME.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A hammer with a titanium alloy striking face, comprising a main body and a striking face, characterized in that:
the main body is made of a metallic material and includes a connecting end;
the striking face is made of β titanium alloy having a hardness above HRC 45; and
the striking face is coupled to the connecting end of the main body.

2. The hammer with a titanium alloy striking face as claimed in claim 1, wherein the main body is made of A164 titanium alloy.

3. The hammer with a titanium alloy striking face as claimed in claim 1, wherein the main body is made of steel.

4. The hammer with a titanium alloy striking face as claimed in claim 1, wherein the main body is made of stainless steel.

5. The hammer with a titanium alloy striking face as claimed in claim 1, wherein the main body further includes a claw portion.

6. The hammer with a titanium alloy striking face as claimed in claim 1, wherein the connecting end of the main body has an opening and the striking face has a protrusion, and the protrusion is inserted into the opening so that the striking face is coupled to the connecting end of the main body.

7. The hammer with a titanium alloy striking face as claimed in claim 6, wherein the main body further has a pin hole at one side thereof, the pin hole communicates with the opening, the protrusion of the striking face has a through hole corresponding to the pin hole, and a pin is inserted into the pin hole of the main body and the through hole of the protrusion to firmly secure the main body and the striking face together.

8. The hammer with a titanium alloy striking face as claimed in claim 7, wherein a magnetic block is embedded in the pin hole after the pin is inserted into the pin hole of the main body and the through hole of the protrusion.

9. The hammer with a titanium alloy striking face as claimed in claim 8, wherein a nail trough is provided close to the magnetic block.

10. The hammer with a titanium alloy striking face as claimed in claim 1, wherein one side of the hammer is coupled with a handle.
